(19) United States
(12) Patent Application Publication
(10) Pub. No.: US 2014/0029494 A1
(43) Pub. Date: Jan. 30, 2014

(54) POWER SAVING FOR A MOBILE DEVICE IN A WIRELESS COMMUNICATION NETWORK

(71) Applicants: Sundaresan Sundaram, Bangalore (IN); K. Subramanian, Bangalore (IN); Karthik Narayana, Bangalore (IN); Suresh Raj, Bangalore (IN)

(72) Inventors: Sundaresan Sundaram, Bangalore (IN); K. Subramanian, Bangalore (IN); Karthik Narayana, Bangalore (IN); Suresh Raj, Bangalore (IN)

(73) Assignee: MOTOROLA SOLUTIONS, INC., Schaumburg, IL (US)

(21) Appl. No.: 13/560,145

(22) Filed: Jul. 27, 2012

(51) Int. Cl. H04W 52/02

(52) U.S. Cl. 370/311

(57) ABSTRACT

A method and apparatus for power saving for a mobile device in a wireless communication network includes a transceiver operable within an allocated spectrum of the wireless communication network. A detector is operable to detect a signal outside of the allocated spectrum of the wireless communication network transmitted from a network device. A processor is operable to configure the mobile device to be in a sleep mode wherein the transceiver is not operable and the detector is operable, and awaken the transceiver from sleep mode upon detecting the signal in order for the transceiver to communicate between an access point of the wireless communication network and the mobile device within the allocated spectrum of the wireless communication network.

### FIELD OF THE DISCLOSURE

The present invention relates generally to wireless communication networks and more particularly to power saving for a mobile device in a wireless communication network.

### BACKGROUND

Wireless communication networks, such as wireless wide-area network or wireless local-area networks (WLAN) such as IEEE 802.11 (Wi-Fi) wireless communication networks are able to provide communications for mobile devices utilizing wireless access support through local access points (AP), i.e. Wi-Fi hotspots. Often, WLAN systems overlap cellular systems, and the mobile device can have a choice of which system it can use. Presently, 3G/4G cellular systems are experiencing more and more traffic, since data hungry applications on the handheld devices, smart phones, tablets, and laptops are creating more and more congestion in the 3G4G cellular networks. Accordingly, cellular operators are trying to offload the data from their cellular networks onto Wi-Fi access points by providing free Wi-Fi access through these hotspots.

However, many users of handheld devices, smart phones, tablets, and laptops turn off their Wi-Fi reception to prolong battery life, inasmuch as constant or periodic searching for a Wi-Fi network drains the battery. Therefore, some technique is needed to inform these devices that they are in a Wi-Fi hotspot area so that they can turn-on their Wi-Fi reception in order to offload data from the cellular carrier.

Some solutions to this problem have been to provide a dedicated femto-cell within the Wi-Fi hotspot. They femto-cell will have a similar range as the hotspot and can communicate with devices to have the devices turn-on their Wi-Fi reception in order to offload data from the cellular carrier. However, these solutions require an expensive femto-cell station and use specially defined cellular protocols in order to communicate with the devices to turn-on their Wi-Fi reception.

Accordingly, there is a need for a new power saving technique to have devices turn-on their Wi-Fi reception without requiring expensive cellular hardware or special cellular protocols.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a WLAN communication system, in accordance with the present invention.

FIG. 2 is a simplified flow diagram of power saving for a mobile device in a WLAN communication system, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a novel technique for power saving in a mobile device in a WLAN communication system. The novel technique has devices turn-on their Wi-Fi reception without requiring expensive cellular hardware or special cellular protocols. In particular, the WLAN provides a signal to the mobile device over non-WLAN spectrum to indicate to the device that it should wake up its WLAN transceiver. The signal can be provided to the device using an acoustic, optical, or non-WLAN RF system. Preferably, the device can use existing acoustic, optical, or non-WLAN RF receivers that are already present on the device. Alternatively, these receivers could be modified to better detect the signal, or specialized receivers could be installed in the device. The signal could be supplied by a modified/unmodified WLAN entity, such as an existing access point or other WLAN device.

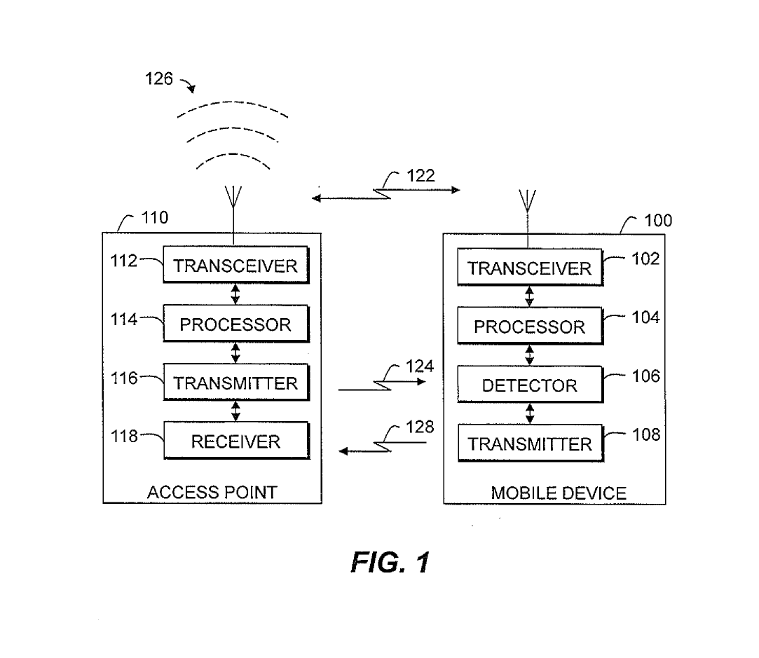

FIG. 1 is a block diagram depiction of one embodiment of the present invention utilizing a wireless local-area communication network (WLAN), including IEEE 802.11 wireless communication systems, as the example described herein. However, it should be recognized that the present invention is also applicable to other wireless communication systems. At present, standards bodies such as OMA (Open Mobile Alliance), 3GPP (3rd Generation Partnership Project), 3GPP2 (3rd Generation Partnership Project 2) and IEEE (Institute of Electrical and Electronics Engineers) 802 are developing standards specifications for such wireless telecommunications systems. The communication system represents a system operable in a network that may be based on different wireless protocols. For example, the description that follows can apply to a wireless wideband area network or other network, employing wireless technologies such as IEEE's 802.11, 802.16, 802.20, or others modified to implement embodiments of the present invention.

Referring to FIG. 1, there is shown a block diagram of wireless communication network having at least one access point (AP) 110, or other network entity such as a wireless switch for example, and at least one mobile device 100 adapted to support the inventive concepts of the embodiments of the present invention. Those skilled in the art will recognize that FIG. 1 does not depict all of the network equipment necessary for system to operate but only those system components and logical entities particularly relevant to the description of the embodiments herein. For example, an access port, access point, eNodeB, or base station can be connected with or comprise one or more devices such as wireless area network stations (which include access nodes (ANs), Media Access Controllers (MAC), AP controllers, and/or switches), base transceiver stations (BTSs), base site controllers (BSCs), packet control functions (PCFs), packet control units (PCUs), and/or radio network controllers (RNCs). However, none of these other devices are specifically shown in FIG. 1.

Mobile device 100 is depicted as comprising a processor 104 coupled to a transceiver 102 and a detector 106. AP 110 is depicted as comprising a processor 114, transceiver 112, and transmitter 116. The AP 110 uses a local area wireless interface for communication with at least one mobile device 100. The local area wireless interface can include a forward link and a reverse link used in communications 122 between the mobile device and the AP transceivers 102, 112. In general, components such as processors and transceivers are well-known. For example, the transceivers 102, 112 can be operable to communicate with user devices over an IEEE 802.11 interface. In addition, processing units 104, 114 are known to comprise basic components such as, but not limited to, microprocessors, digital signal processors, microcontrollers, memory devices, application-specific integrated circuits, and/or logic circuitry. Such components are typically adapted to implement algorithms and/or protocols that have been expressed using high-level design languages or descriptions, expressed using computer instructions, expressed using messaging/signaling logic flow diagrams, and/or expressed using logic flow diagrams. Thus, given an algorithm, a logic flow, a messaging/signaling flow, a call flow, and/or a protocol specification, those skilled in the art are aware of the many design and development techniques available to implement processors that perform the given logic.

Mobile devices can also comprise an antenna, a keypad, a speaker, a microphone, a display, and the like, as are known in the art. Therefore, mobile device 100 represents a known apparatus that has been adapted, in accordance with the description herein, to implement various embodiments of the present invention. Mobile devices or remote unit platforms are known to refer to a wide variety of consumer electronic platforms such as clients, mobile stations, mobile nodes, user equipment, user stations, subscriber equipment, subscriber stations, access terminals, remote terminals, terminal equipment, gaming devices, personal computers, and personal digital assistants, and the like, all referred to herein as mobile device.

The AP 110 includes a transmitter 116, and the mobile device includes a detector 106 or receiver. The transmitter and receiver are complementary devices inasmuch as the detector is able to detect a signal 124 from the transmitter. In one embodiment, the transmitter is an acoustic transponder, emitter, or speaker, and the detector is an acoustic transducer, wherein the signal is an infrasonic, audio, or ultrasonic acoustic signal. These acoustic devices could be existing microphones and speakers of the respective mobile device and AP. In another embodiment, the transmitter is an optical light emitting diode or light source, and the detector is an optical receiver, diode, or sensor, wherein the signal is an infrared, visible, or ultraviolet optical signal. These optical devices could be existing infrared or visible light communication port of the AP, and an existing ambient light sensor or infrared port of the mobile device, respectively. In yet another embodiment, the transmitter is a radio frequency (RF) transmitter or transceiver, and the detector is an RF transceiver or receiver, wherein the signal is an RF signal operable outside of the WLAN spectrum (e.g. IEEE 802.11), such as an IEEE 802.15 system. These RF devices could be existing components in the AP and mobile device, such as Bluetooth™ transceivers. As described above, the transmitter and detector could be existing devices in the AP and mobile device or could be new components embedded in these devices and specifically configured for the present invention. Alternatively, the transmitter could be a device external to the AP, but under control of the WLAN.

Referring back to FIG. 1, in a first embodiment, the present invention provides a novel technique to provide a power saving or sleep mode for a mobile device in a WLAN. The mobile device 100 includes a transceiver 102 operable to communicate within an allocated spectrum of the wireless communication network, such as an IEEE 802.11 network. The mobile device also includes a detector 106 operable to detect a signal 124 outside of the allocated spectrum of the wireless communication network transmitted from a transmitter 116 of a network device 110. The network device can be one AP or a set of APs that each can be connected or networked to a single transmitter 116. Alternatively, the signal could be provided by another network entity, or can be provided by an external device under control of the WLAN and specifically configured for the present invention, i.e. transmitter 116 is external to the AP.

The mobile device also includes a processor 104 coupled to the transceiver and the detector. The processor is operable to configure the mobile device to be in a sleep mode where the transceiver is not operable while the detector is still operable. The processor will awaken the transceiver from sleep mode upon detecting the signal. The transceiver 102 can then communicate 122 normally with an access point transceiver 112 of the wireless communication network within the allocated spectrum of the wireless communication network.

The signal 124 can be transmitted in various non-IEEE 802.11 network forms, i.e. transmitted on a spectrum outside of the normal communication spectrum used in the WLAN. In one embodiment, the signal is an optical signal and the detector is an existing ambient light sensor of the mobile device able to receive the signal. In another embodiment, the signal is an acoustic signal and the detector is an acoustic transducer provided for the mobile device. In yet another embodiment, the signal is an IEEE 802.15-compliant signal, and the detector is an IEEE 802.15-compliant receiver of the mobile device able to receive the signal, and wherein the wireless communication network is operable using IEEE 802.11 network protocols.

In its simplest embodiment the signal is simply a light. The light can have a special character recognized by the processor 104, wherein processor can simply wake up the transceiver 102 for it to start listening for the next WLAN beacon 126. The light could have a defined (color) frequency that can be detected by an existing (modified or unmodified) ambient light sensor 106 of the mobile device and recognized by the processor. Optionally, the light can be turned on/off with a defined timing period and/or duty cycle recognizable by the processor 104. The light can be transmitted directly by the AP or by a set of APs that each can be connected or networked to a single transmitter 116, such as an existing or customized lighting system. The light could also be transmitted by any other device under control of the WLAN.

In addition, the signal can carry information. For example, the AP processor 114 can modulate information onto the signal, such as network identification information readable by the mobile device processor 104. In particular, the signal can be a beacon containing all the information available a normal WLAN beacon. Similarly, the signal can contain all the information exchanges specified in IEEE 802.11u and Hotspot 2.0. In this way, sending information in the signal can fully automate the network discovery, registration, provisioning and access steps that a Wi-Fi user presently experiences when connecting to a given Wi-Fi network. While Hotspot 2.0 achieves this using the Wi-Fi beacons, the present invention could use the signal for transmitting (broadcasting) the Wi-Fi network parameters, which would eliminate the Wi-Fi search procedure to a great extent. In these scenarios, network information is transmitted in the signal over non-network spectrum, e.g. optical spectrum.

Further, the beacon 124 can be transmitted synchronously with a normal access point beacon 126 being transmitted within the allocated spectrum of the WLAN. In this case, the beacon 124 and access point beacon 126 contain the same information and are transmitted from the same access point 110. In this way, the mobile device could wake up and immediately begin to associate with the access point without waiting to receive a normal WLAN beacon.

Alternatively, the AP can also have a sleep mode, where its transceiver 112 is shut down when there is no usage. This requires that the mobile device 100 include a further signal transmitter 108 and the access point 110 include a further signal receiver 118, i.e. both devices now include complete (optical) signal transceivers. In this scenario, the AP can enter a power saving mode in which it shuts down its Wi-Fi transceiver 112 when there is no network traffic, but the associated (optical) transmitter 116 and receiver 118 are kept “on” to broadcast the Wi-Fi network parameters over the signal 124. When a mobile device arrives, it can determine the existence of the Wi-Fi network by detecting the signal 124, and upon detecting the signal the mobile device can then transmit a wake up request 128 to the AP over the non-network (optical) spectrum. Upon detecting the wake up request 128 on its (optical) signal receiver 118, the AP can then turn on (awaken) its Wi-Fi transceiver 112 to resume normal operations.

In any of the above scenarios, the processor 104 is further operable to return the transceiver 102 to sleep mode if the signal 124 is not detected for a predetermined time period (and optionally the AP processor 114 is operable to return the transceiver 112 to sleep mode if there is no usage of transceiver 112).

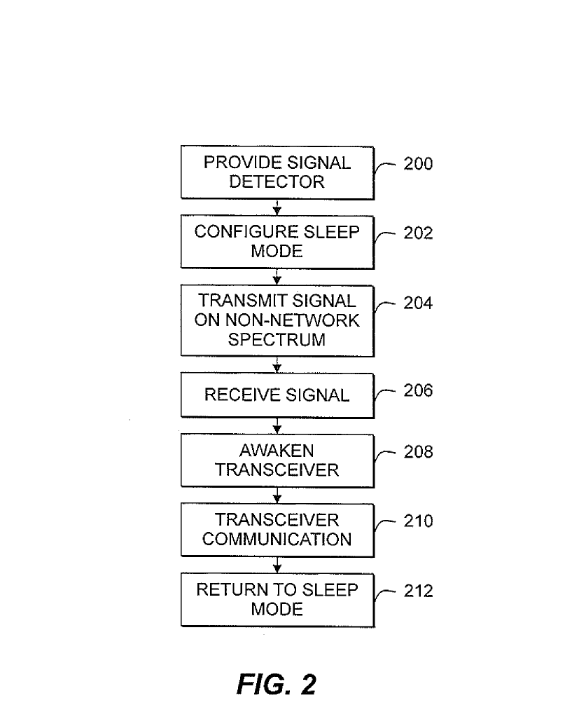

FIG. 2 illustrates a flowchart of a method for power saving for a mobile device in a wireless communication network.

One step of the method includes providing 200 the mobile device with a transceiver operable to communicate within an allocated spectrum of the wireless communication network, and providing the mobile device with a detector to detect a signal outside of the allocated spectrum of the wireless communication network.

Another step of the method includes configuring 202 the mobile device to be in a sleep mode, wherein the transceiver is not operable and the detector is operable.

Another step of the method includes, transmitting 204 the signal over non-network spectrum. In one embodiment, where beacon the signal is a beacon, transmitting occurs synchronously with an access point beacon being transmitted within the allocated spectrum of the wireless communication network, and wherein the beacon and access point beacon contain the same information and are transmitted from the same access point.

Another step of the method includes receiving 206 a signal by the detector from a network device of the wireless communication network, the signal being outside of the allocated spectrum of the wireless communication network.

Another step of the method includes awaking 208 the transceiver from sleep mode upon receiving the signal. This step can optionally include the mobile device sending a wake up request to an access point over the non-network (optical) spectrum in order for the AP to turn on its Wi-Fi transceiver if it was in sleep mode.

Another step of the method includes communicating 210 between an access point of the wireless communication network and the mobile device using the transceiver within the allocated spectrum of the wireless communication network.

A further step of the method includes returning 212 the transceiver to sleep mode if the signal is not detected for a predetermined time period. This step can optionally include returning the access point transceiver into sleep mode, if it is so capable, when there is no usage of the access point transceiver.

Advantageously, the present invention provides a novel technique for power saving in a mobile device in a WLAN communication system, wherein the novel technique has devices turn-on their Wi-Fi reception without requiring expensive cellular hardware or special cellular protocols.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs for ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile device having a power saving mode in a wireless communication network, the mobile device comprising:
a transceiver operable to communicate within an allocated spectrum of the wireless communication network;
a detector operable to detect a signal outside of the allocated spectrum of the wireless communication network transmitted from a network device; and
a processor coupled to the transceiver and the detector, the processor operable to configure the mobile device to be in a sleep mode where the transceiver is not operable and the detector is operable, and awaken the transceiver from sleep mode upon detecting the signal in order for the transceiver to communicate between an access point of the wireless communication network and the mobile device within the allocated spectrum of the wireless communication network.

2. The mobile device of claim 1, wherein the signal is a beacon including with network identification information readable by the processor.

3. The mobile device of claim 1, wherein the signal is an optical signal and the detector is an existing ambient light sensor of the mobile device able to receive the signal.

4. The mobile device of claim 1, wherein the signal is an acoustic signal and the detector is an acoustic transducer provided for the mobile device.

5. The mobile device of claim 1, wherein the signal is an IEEE 802.15-compliant signal, and the detector is an IEEE 802.15-compliant receiver of the mobile device able to receive the signal, and wherein the wireless communication network is operable using IEEE 802.11 protocols.

6. The mobile device of claim 1, wherein the network device is at least one access point.

7. The mobile device of claim 1, wherein the signal is a beacon that is transmitted synchronously with an access point beacon being transmitted within the allocated spectrum of the wireless communication network, and wherein the beacon and access point beacon contain the same information and are transmitted from the same access point.

8. The mobile device of claim 1, wherein the processor is further operable to return the transceiver to sleep mode if the signal is not detected for a predetermined time period.

9. The mobile device of claim 1, further comprising a signal transmitter operable to transmit a wake up request to an access point over the non-network spectrum to awaken a transceiver of the access point.

10. A system for power saving for a mobile device in a wireless communication network, the system comprising:
a mobile device comprising:
a transceiver operable to communicate within an allocated spectrum of the wireless communication network;
a detector operable to detect a signal outside of the allocated spectrum of the wireless communication network transmitted from a network device; and
a processor coupled to the transceiver and the detector, the processor operable to configure the mobile device to be in a sleep mode where the transceiver is not operable and the detector is operable, and awaken the transceiver from sleep mode upon detecting the signal in order for the transceiver to communicate between an access point of the wireless communication network and the mobile device within the allocated spectrum of the wireless communication network; and
a network device operable to transmit the signal.

11. The system of claim 10, wherein the signal is modulated with a service set identifier of the wireless communication network readable by the processor.

12. The system of claim 10, wherein the network device is at least one access point of the wireless communication network, the signal is an optical signal, and the detector is an existing ambient light sensor of the mobile device able to receive the signal.

13. The system of claim 10, wherein the signal is a beacon that is transmitted synchronously with an access point beacon being transmitted within the allocated spectrum of the wireless communication network, and wherein the beacon and access point beacon contain the same information and are transmitted from the same access point.

14. The system of claim 10, wherein the mobile device includes a signal transmitter, and wherein the network device is an access point of the wireless communication network that includes a processor, a transceiver operable within the allocated spectrum of the wireless communication network, and a signal transmitter and receiver operable outside of the allocated spectrum of the wireless communication network, and wherein upon the mobile device detector detecting the signal the mobile device transmitter transmits a wake up request to the AP outside of the allocated spectrum of the wireless communication network to the signal receiver to awaken the access point transceiver.

15. The system of claim 14, wherein the access point processor is operable to return the access point transceiver to sleep mode if there is no usage of access point transceiver.

16. A method for power saving for a mobile device in a wireless communication network, the method comprising the steps of:
providing the mobile device with a transceiver operable to communicate within an allocated spectrum of the wireless communication network, and providing the mobile device with a detector to detect a signal outside of the allocated spectrum of the wireless communication network;
configuring the mobile device to be in a sleep mode where the transceiver is not operable and the detector is operable;
receiving a signal by the detector from a network device of the wireless communication network, the signal being outside of the allocated spectrum of the wireless communication network;
awaking the transceiver from sleep mode upon receiving the signal; and
communicating between an access point of the wireless communication network and the mobile device using the transceiver within the allocated spectrum of the wireless communication network.

17. The method of claim 16, wherein the signal is a beacon, and further comprising the step of transmitting the beacon synchronously with an access point beacon being transmitted within the allocated spectrum of the wireless communication network, and wherein the beacon and access point beacon contain the same information and are transmitted from the same access point.

18. The method of claim 16, further comprising returning the transceiver to sleep mode if the signal is not detected for a predetermined time period.

19. The method of claim 16, wherein the awaken step includes the mobile device sending a wake up request to an access point outside of the allocated spectrum of the wireless communication network in order for the access point to awaken its transceiver operable on the allocated spectrum of the wireless communication network.

20. The method of claim 19, further comprising returning the access point transceiver into sleep mode when there is no usage of the access point transceiver.
